(19) United States
(12) Patent Application Publication
(10) Pub. No.: US 2014/0099847 A1
(43) Pub. Date: Apr. 10, 2014

(54) ANTI-SLIP STRUCTURE

(71) Applicant: Sing Pong International Co., Ltd, Taipei (TW)

(72) Inventor: Victor TSAI, Taipei City (TW)

(73) Assignee: Sing Pong International Co., Ltd, Taipei (TW)

(21) Appl. No.: 14/047,247

(22) Filed: Oct. 7, 2013

(30) Foreign Application Priority Data
Oct. 9, 2012 (TW) 101137301

(51) Int. Cl. B32B 5/26

(52) U.S. Cl. CPC B32B 5/26
USPC 442/1; 442/381

(57) ABSTRACT

An anti-slip structure includes a thermosetting plastic layer, a first thermoplastic elastomer layer, a first fabric layer sandwiched between the thermosetting plastic layer and the first thermoplastic elastomer layer in such a manner that the thermosetting plastic layer is partially embedded in the first fabric layer, a second thermoplastic elastomer layer, and a second fabric layer sandwiched between the first thermoplastic elastomer layer and the second thermoplastic elastomer layer.

### BACKGROUND OF THE INVENTION

1. Field of the Invention

The present invention relates to plastic mats and more particularly, to an anti-slip structure.

2. Description of the Related Art

With the popularity of the trend of sports, the demand for anti-slip products for sports application keeps increasing day by day. In consequence, a wide variety of anti-slip products have been gradually created. For example, Taiwan Utility M423618 discloses an anti-slip mat entitled “Multi-layer three-dimensional mesh material structure” that is composed of at least one composite structure and a sub cladding material. The composite structure is stacked on the sub cladding material. Further, the composite structure comprises a three-dimensional mesh material, and a cladding material stacked on the three-dimensional mesh material. The cladding material is a woven fabric of elastic fibers (i.e., polyurethane) blended with non-resilient fibers (i.e., nylon fibers, polyester fibers, cotton or polypropylene fibers), i.e., the cladding material is made using textile techniques. The three-dimensional mesh material is a woven fabric of a thermoplastic elastomer material. Because the cladding material and three-dimensional mesh material of the composite structure are made using textile techniques, the manufacturing process for making the aforesaid prior art anti-slip mat is complicated.

### SUMMARY OF THE INVENTION

The present invention has been accomplished under the circumstances in view. It is the main object of the present invention to provide an anti-slip structure, which eliminates e drawbacks of the prior art design. To achieve this and other objects of the present invention, an anti-slip structure in accordance with the present invention comprises a thermosetting plastic layer, a first fabric layer, a first thermoplastic elastomer layer, a second fabric layer and a second thermoplastic elastomer layer. The first fabric layer is bonded to the thermosetting plastic layer. The thermosetting plastic layer is covered on the top wall of the first fabric layer. The first thermoplastic elastomer layer is bonded to the first fabric layer and covered on the bottom wall of the first fabric layer. The thermosetting plastic layer is partially embedded in the first fabric layer. The second fabric layer is bonded to the first thermoplastic elastomer layer. The first thermoplastic elastomer layer is covered on the top wall of the second fabric layer. The second thermoplastic elastomer layer is bonded to the second fabric layer, and covered on the bottom wall of the second fabric layer. Thus, the anti-slip structure of the present invention has the characteristics of non-slip, wear resistance and high elasticity.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of an anti-slip structure in accordance with the present invention.

FIG. 2 is a schematic assembly view of the anti-slip structure shown in FIG. 1.

FIG. 3 is an exploded of an alternate form of the anti-slip structure in accordance with the present invention.

### DETAILED DESCRIPTION OF THE INVENTION

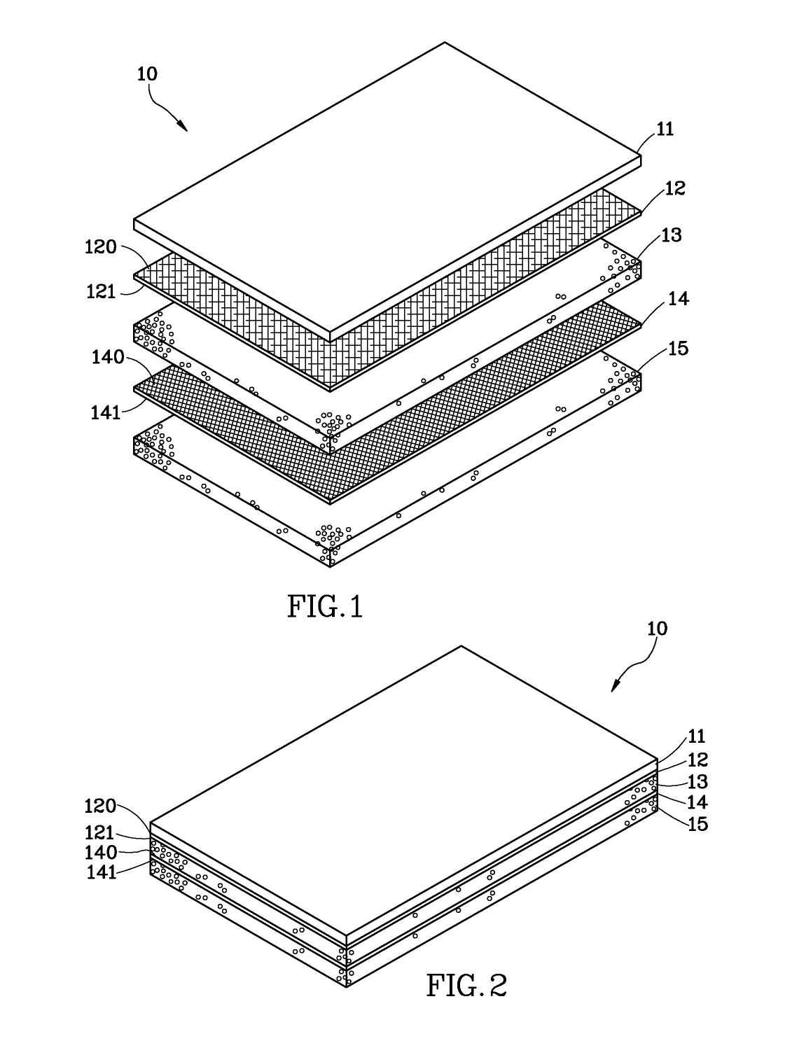

Referring to FIGS. 1 and 2; an exploded view and a schematic assembly view of an anti-slip structure in accordance with the present invention is shown. As illustrated, the anti-slip structure 10 comprises a thermosetting plastic layer 11, a first fabric layer 12, a first thermoplastic elastomer layer 13, a second fabric layer 14 and a second thermoplastic elastomer layer 15. The first fabric layer 12 is bonded to the thermosetting plastic layer 11 such that the thermosetting plastic layer 11 covers the top wall 120 of the first fabric layer 12 and is partially embedded in the first fabric layer 12. The first thermoplastic elastomer layer 13 is bonded to the first fabric layer 12 and covered on the bottom wall 121 of the first fabric layer 12 opposite to the thermosetting plastic layer 11. The second fabric layer 14 is bonded to the first thermoplastic elastomer layer 13 such that the first thermoplastic elastomer layer 13 covers the top wall 140 of the second fabric layer 14. The second thermoplastic elastomer layer 15 is bonded to the second fabric layer 14 and covered on the bottom wall 141 of the second fabric layer 14. The anti-slip structure 10 of the present invention is formed of the aforesaid five layers.

The thermosetting plastic layer 11 is selected from the group of polyurethane (PU), epoxy resin, unsaturated polyester and bakelite (phenolic) plastic, preferably polyurethane (PU), for the advantage of more environmentally friendly than polyvinyl chloride (PVC). In actual practice, epoxy resin, unsaturated polyester or bakelite (phenolic) plastic can be selectively used to substitute for polyurethane (PU).

The first fabric layer 12 is selected from a nonwoven fabric. Subject to the characteristic of inextensibility of nonwoven fabric, the first fabric layer 12 gives excellent support to the thermosetting plastic layer 11. Further, the nonwoven fabric can be a multilayer textile structure. When the material of the thermosetting plastic layer 11 is heated, the material of the thermosetting plastic layer 11 will permeate the nonwoven fabric through its surface and spread therein, forming a stable structure. Further, the nonwoven fabric can be made from nylon fibers, polyester fibers, cotton, hemp polypropylene fibers.

The first thermoplastic elastomer layer 13 and the second thermoplastic elastomer layer 15 are made from a composite material that comprises a soft-segment plastic material blended with a hard-segment plastic material, for example, the composite material can be thermoplastic elastomer (TPE) that combines the characteristics of rubber and plastic. During fabrication of thermoplastic elastomer (TPE), soft-segment plastic (for example, rubber) and hard-segment plastic (for example, plastics) are blended. When heating the blended materials to a specific temperature, the soft-segment plastic and the hard-segment plastic are melted, forming an elastomer. Under room temperature, the soft-segment plastic is elastic, and the hard-segment plastic plays the role of preventing plastic deformation. The soft-segment plastic can be selected from the group of polyvinyl chloride (PVC), polyethylene-butene, nitrile butadiene rubber (NBR), styrene-butadiene rubber (SBR), styrene ethylene butylene styrene rubber (SEBS), thermoplastic polyolefin (TPO), thermoplastic rubber (TPR), ethylene vinyl acetate (EVA), polyethylene (PE), and acrylic. The hard-segment plastic can be selected from the group of polyethylene, polystyrene, polypropylene, polyurethane, polyesters and polyamides.

Further, the first thermoplastic elastomer layer 13 and the second thermoplastic elastomer layer 15 are preferably made from the same composite material, i.e., the composite material for the first thermoplastic elastomer layer 13 and the composite material for the second thermoplastic elastomer layer 15 are made of a soft-segment plastic and a hard-segment plastic in the same formula and at the same ratio.

The second fabric layer 14 is made from a mesh fabric or nonwoven fabric, achieving the same effects of the first fabric layer 12 to support the first thermoplastic elastomer layer 13 and the second thermoplastic elastomer layer 15. However, it is to be noted that the second fabric layer 14 can also be made by weaving using the same material for the first fabric layer 12. The first fabric layer 12 can also be made from a mesh fabric instead of the use of a nonwoven fabric. Thus, when compared to the prior art technique, the anti-slip structure 10 is more easy to produce and has the characteristics of comfort, non-slip and wear resistance.

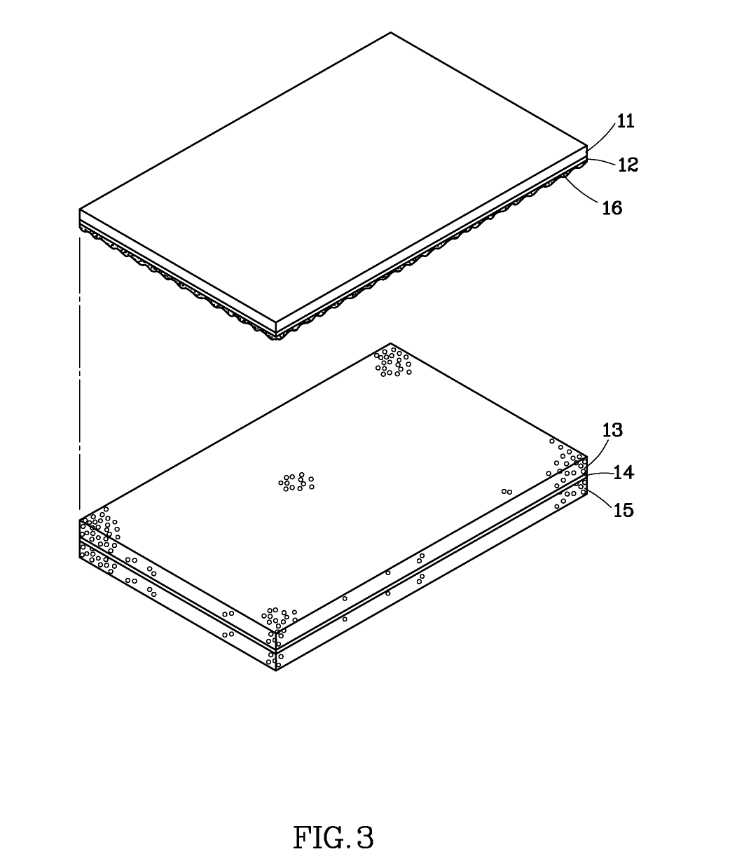

Referring to FIG. 3, an alternate form of the anti-slip structure in accordance with the present invention is shown. In the embodiment shown in FIG. 1, the thermosetting plastic layer 11 and the first fabric layer 12 are directly bonded together, and the second fabric layer 14 is directly bonded with the first thermoplastic elastomer layer 13 and the second thermoplastic elastomer layer 15. According to this alternate form, the anti-slip structure further comprises an adhesive layer 16 covered on the bottom wall of the first fabric layer 12 and adhered to the top wall of the first thermoplastic elastomer layer 13, i.e., the thermosetting plastic layer 11 and the first fabric layer 12 are separately made, and then the second fabric layer 14 is directly bonded with the first thermoplastic elastomer layer 13 and the second thermoplastic elastomer layer 15, and then the adhesive layer 16 is covered on the bottom wall of the first fabric layer 12 and then adhered to the top wall of the first thermoplastic elastomer layer 13, simplifying the fabrication of the anti-slip structure 10. In actual practice, the adhesive layer 16 can be coated on the top wall of the first thermoplastic elastomer layer 13 and then adhered to the bottom wall of the first fabric layer 12.

Further, the first fabric layer 12 and the thermosetting plastic layer num be adhered together using an adhesive instead of the aforesaid bonding method of heating the thermosetting plastic layer 11. Further, the second fabric layer 14 can be bonded to the first thermoplastic elastomer layer 13 and the second thermoplastic elastomer layer 15 by employing a dip molding process or adhesive process.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An anti-slip structure, comprising:
a thermosetting plastic layer;
a first fabric layer bonded to said thermosetting plastic layer and covered on a bottom wall of said thermosetting plastic layer in such a manner that a part of said thermosetting plastic layer is embedded in said first fabric layer;
a first thermoplastic elastomer layer bonded to said first fabric layer and covered on a bottom wall of said first fabric layer opposite to said thermosetting plastic layer;
a second fabric layer bonded to said first thermoplastic elastomer layer and covered on a bottom wall of said first thermoplastic elastomer layer opposite to said thermosetting plastic layer and said first fabric layer; and
a second thermoplastic elastomer layer bonded to said second fabric layer and covered on a bottom wall of said second fabric layer opposite to said first thermoplastic elastomer layer.

2. The anti-slip structure as claimed in claim 1, wherein said thermosetting plastic layer is selected from the group of polyurethane, epoxy resin, unsaturated polyester and bakelite.

3. The anti-slip structure as claimed in claim 1, wherein said first thermoplastic elastomer layer and said second thermoplastic elastomer layer are respectively made from a composite material of a soft-segment plastic blended with a hard segment plastic, said soft-segment plastic being selected from the group of polyvinyl chloride (PVC), polyethylene-butene, nitrile butadiene rubber (NBR), styrene-butadiene rubber (SBR), styrene ethylene butylene styrene rubber (SEBS), thermoplastic polyolefin (TPO), thermoplastic rubber (TPR), ethylene vinyl acetate (EVA), polyethylene (PE), and acrylic, said hard-segment plastic being selected from the group of polyethylene, polystyrene, polypropylene, polyurethane, polyesters and polyamides.

4. The anti-slip structure as claimed in claim 3, wherein said first thermoplastic elastomer layer and said second thermoplastic elastomer layer are respectively made from the same composite material.

5. The anti-slip structure as claimed in claim 1, wherein said first fabric layer is made from a mesh fabric or nonwoven fabric.

6. The anti-slip structure as claimed in claim 1, wherein said second fabric layer is made from a mesh fabric or nonwoven fabric.

7. The anti-slip structure as claimed in claim 1, further comprising an adhesive layer sandwiched between said first fabric layer and first thermoplastic elastomer layer.
